(19) United States
(12) Patent Application Publication
(10) Pub. No.: US 2026/0161218 A1
(43) Pub. Date: Jun. 11, 2026

(54) AI MODEL PROVISION CONTROL SYSTEM, PROCESSING METHOD OF AI MODEL PROVISION CONTROL SYSTEM, AND STORAGE MEDIUM STORING PROGRAM

(71) Applicant: CANON KABUSHIKI KAISHA, Tokyo (JP)

(72) Inventor: TAKAHISA YAMAMOTO, Kanagawa (JP)

(21) Appl. No.: 19/411,000

(22) Filed: Dec. 5, 2025

(30) Foreign Application Priority Data
Dec. 9, 2024 (JP) 2024-214413

(51) Int. Cl. G06F 3/01; G06T 7/73

(52) U.S. Cl. CPC G06F 3/011; G06T 7/73

(57) ABSTRACT

An artificial intelligence (AI) model provision control system includes an estimation unit configured to estimate, based on information about a user who uses a pre-trained AI model, a use case in a case where the user uses the AI model, and a determination unit configured to determine whether the user is suitable for using the AI model based on the estimated use case.

### BACKGROUND

### Field of the Technology

The present disclosure relates to an artificial intelligence (AI) model provision control system, a processing method of the AI model provision control system, and a storage medium storing a program.

### Description of the Related Art

In recent years, many technologies for performing advanced image processing on images and extracting useful information from the images have been proposed. Among such technologies that have been the subject of research and development is facial authentication using a multilayer neural network called “Deep Net” (or also referred to as “Deep Neural Network” or “Deep Learning”). In facial authentication, a facial image is input to a deep net and is compared with a facial image that has been registered in advance in order to determine whether the input facial image is the image of the same person whose facial image has been registered.

Japanese Patent Laid-Open No. 2023-64626 describes a server including a processor configured to specify AI ethics that a pre-trained model needs to satisfy and determine whether the pre-trained model satisfies the AI ethics based on learning conditions and the AI ethics.

There has been significant progress in technology for extracting information from images by using AI. In particular, installation of facial authentication in public places is also being discussed from the standpoint of safety and security.

On the other hand, the use of facial authentication raises concerns from the standpoint of a privacy violation, etc. As such, there is a discussion suggesting that it is desirable to impose a certain level of restriction on the use of facial authentication. For example, in the European Union (EU), there is an ongoing discussion about introducing a law that prohibits the use of AI that performs a large-scale monitoring activity by using facial authentication or biometric identification technology in public places.

It can be said that biometric identification technologies such as facial authentication can provide users with many advantages such as the ability to confirm their ID without memorizing passwords or the like. On the other hand, it can also be said that biometric identification technologies may violate privacy and human rights of people unless the use of biometric identification technologies is carefully considered. Accordingly, it is necessary to give sufficient consideration to the risk of violating privacy and human rights in the use of biometric identification technologies such as facial authentication.

It is widely practiced to make pre-trained AI models public on the Internet and to share these AI models among AI developers and AI users. In a case of services for providing such pre-trained AI models, it is very difficult to keep track of how an individually provided AI model is used by a recipient or to limit its use method at the recipient’s end.

In addition, a technique for estimating how an AI model is used has not yet been studied. Furthermore, a technique for stopping an AI model from being used when it is determined that the AI model is likely to be inappropriately used has not yet been studied.

### SUMMARY

The present disclosure is directed to enabling appropriate determination about whether a user is suitable for using an AI model.

According to the present disclosure, an artificial intelligence (AI) model provision control system includes an estimation unit configured to estimate, based on information about a user who uses a pre-trained AI model, a use case in a case where the user uses the AI model, and a determination unit configured to determine whether the user is suitable for using the AI model based on the estimated use case.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an artificial intelligence (AI) model provision control system.

FIG. 2 schematically illustrates a user information management method.

FIG. 3 schematically illustrates an AI model management state.

FIG. 4 illustrates an operation sequence of the AI model provision control system.

FIG. 5 schematically illustrates a database for determining the level of the AI ethical risk.

FIG. 6 is a block diagram illustrating a configuration of an AI model provision control system.

FIG. 7 schematically illustrates a user information management method.

FIG. 8 is a block diagram illustrating a configuration of a use case estimation unit.

FIG. 9 illustrates examples of captured images.

FIG. 10 is a block diagram illustrating a configuration of an AI model provision control system.

FIG. 11 illustrates an operation sequence of the AI model provision control system.

FIG. 12 schematically illustrates a user information management method.

### DESCRIPTION OF THE EMBODIMENTS

### (First Embodiment)

A first embodiment will be described based on an example in which a service (which will be referred to as an artificial intelligence (AI) model provision control system), which provides users with various kinds of pre-trained AI models managed by the service, determines whether to provide an AI model capable of performing facial authentication on users.

Facial authentication refers to a personal authentication technique in which information (biometric identifiers) representing an individual is extracted from a facial image of a person, and the information is used to determine the personal identification (ID) of the person.

It has been pointed out that indiscriminate use of facial authentication raises concerns from the standpoint of a privacy violation, and there is a risk of causing violation of privacy and human rights, depending on how the facial authentication is used. To reduce the risk, the AI model provision control system according to the present embodiment refers to information about a recipient of an AI model (a user of an AI model), and estimates the use case of the AI model. Based on the estimation result, if the AI model provision control system determines that the AI model is likely to be used in a way that causes the risk, the AI model provision control system performs a control operation to reject provision of the AI model.

The present embodiment will be described based on a case where the AI model provision control system rejects provision of a facial authentication AI model. Specifically, if it is estimated that providing a facial authentication AI model to a user who wishes to use the facial authentication AI model will result in a situation where the facial authentication AI model is used for criminal investigation, the AI model provision control system rejects provision of the facial authentication AI model.

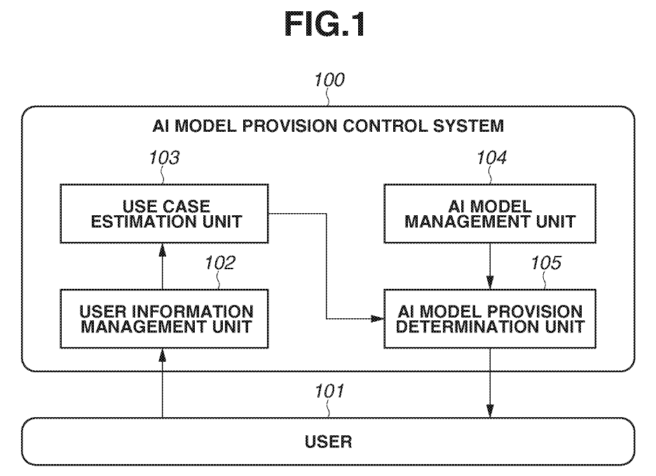

FIG. 1 is a block diagram illustrating a configuration example of an AI model provision control system 100 according to the first embodiment. It is assumed that the AI model provision control system 100 according to the present embodiment manages and provides AI models that are usable with digital cameras.

The AI model provision control system 100 includes a user information management unit 102, a use case estimation unit 103, an AI model management unit 104, and an AI model provision/rejection determination unit 105.

A user 101 refers to a user who wishes to use an AI model managed by the AI model provision control system 100. According to the present embodiment, as described above, the AI model provision control system 100 manages and provides AI models for digital cameras, and thus, the user 101 is assumed to be a digital camera user.

When using the AI model provision control system 100, the user 101 performs user registration by disclosing his or her personal information, and starts using the AI model provision control system 100. The personal information may be, for example, the name of the user, and information about the organization to which the user belongs. Such personal information about the user 101 will be referred to as user information.

The user information management unit 102 manages the user 101 and the user information about the user 101 in association with each other. Since it is assumed that, in general, a plurality of users use the AI model provision control system 100, user information is stored for each user. Accordingly, the user information management unit 102 manages the association between an individual user and his or her personal information (the name and the organization to which the user belongs).

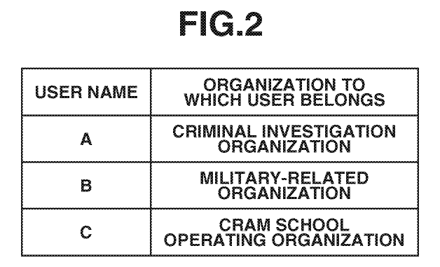

FIG. 2 schematically illustrates a management method of the user information in the user information management unit 102. FIG. 2 indicates how the organizations to which users A, B, and C belong are managed. For example, FIG. 2 illustrates that the user A belongs to a “criminal investigation organization”.

Based on the user information about the corresponding user managed by the user information management unit 102, the use case estimation unit 103 estimates how this user is to use the AI model when the AI model is provided to the user.

For example, since the user A belongs to the “criminal investigation organization”, when the user A receives the AI model, it is estimated that the user A uses a digital camera capable of using the AI model for criminal investigation. In this case, the estimated use case corresponding to the user A is criminal investigation.

Similarly, since the user B belongs to a “military-related organization”, it is expected that the AI model is used as a part of military activities. Further, since the user C belongs to a “cram school operating organization”, use cases such as checking attendance at a class and measuring the degree of concentration on a class by capturing an image of the class with a digital camera can be estimated.

Such estimation of the “use case” from the “organization to which the user belongs” can be realized as follows. A person first estimates various use cases from various organizations to which users belong in advance, next creates a database of the relationship between each use case and a corresponding organization to which a corresponding user belongs, and finally sets the database in the use case estimation unit 103.

Alternatively, the estimation can be realized by using a large-scale language model (LLM), of which usefulness for various kinds of tasks has been rapidly increasing in recent years. Specifically, the estimation can be realized by asking an LLM a question about an AI model use case corresponding to a predetermined organization. In this case, an LLM published by a major IT vendor or the like may be used as it is. Alternatively, a unique LLM obtained by the service provider operating the AI model provision control system 100 after performing additional training, etc. on a published LLM may be used. Since the additional training is performed on an LLM by using, as training data, each relationship between “organization to which the user belongs” and “use case”, which has been estimated by the service provider, it can be expected that a unique LLM more suitable for estimating the use case can be obtained.

The AI model management unit 104 manages pre-trained AI models and achievable tasks of these AI models in association with each other.

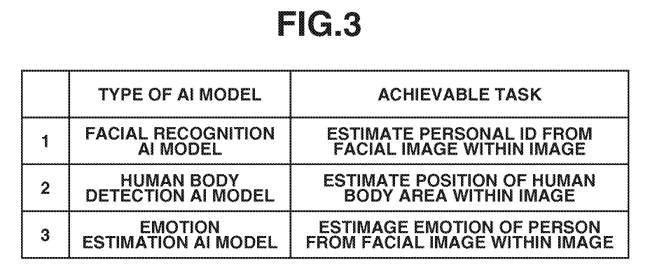

FIG. 3 schematically illustrates an AI model management state in the AI model management unit 104. FIG. 3 illustrates a case where three pre-trained AI models are managed. As described above, in the AI model management unit 104, each pre-trained AI model and its achievable task are managed in association with each other. For example, the first AI model is a “facial authentication AI model” and the task that can be achieved by using this AI model is “estimating a personal ID from a facial image within an image”.

The AI model provision/rejection determination unit 105 determines whether to provide an AI model to the user 101 based on the use case estimated by the use case estimation unit 103 and the achievable task of the AI model managed by the AI model management unit 104. A criterion for this determination is whether using the AI model to be provided in the estimated use case has a high risk of causing an AI ethical problem. That is, if the risk of causing an AI ethical problem is high, the AI model provision/rejection determination unit 105 determines to reject the provision of the AI model. Otherwise, the AI model provision/rejection determination unit 105 determines to provide the AI model.

For example, when the “user A” wishes to use the “facial authentication AI model”, the AI model provision/rejection determination unit 105 determines whether to provide the AI model (in this case, the facial authentication AI model) as follows. In this case, since the use case corresponding to the user A is estimated to be criminal investigation, the facial authentication AI model is highly likely to be used for “determining a personal ID from a facial image within an image in criminal investigation”. It is difficult to say that “using facial authentication AI for criminal investigation” is socially accepted due to mistaken arrests that have occurred in the past, and there is a high risk of causing an AI ethical problem. Accordingly, when the “user A” wishes to use the “facial authentication AI model”, the AI model provision/rejection determination unit 105 rejects the provision of the facial authentication AI model.

Such determination of “the level of the AI ethical risk” from the “combination of the use case and the achievable task of the AI model” can be realized by allowing a person to examine “whether the AI ethical risk is high or low for each combination of a use case and an AI model” in advance. The examination results are compiled into a database, and the database is set in the AI model provision/rejection determination unit 105 to be used for the determination. When the level of the AI ethical risk is examined, information about the laws and regulations concerning AI ethics such as the EU’s AI Act, past cases of occurrence of AI ethical problems, etc., may be referred to.

For example, in the EU’s AI Act, “real-time use of remote biometric identification technology such as facial authentication AI in public places” and “biometric identification AI for criminal behavior prediction and law enforcement purposes” are classified as “prohibited” or “high risk”. A database for determining the risk level can be constructed with reference to such information.

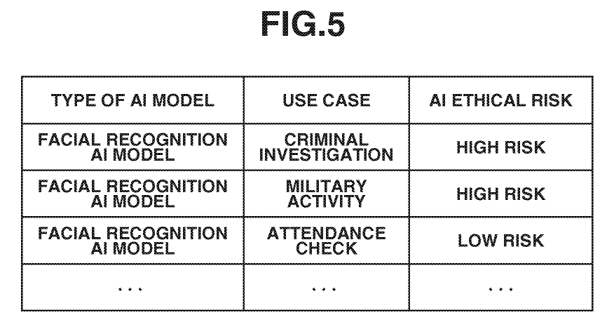

FIG. 5 schematically illustrates a database for determining the level of the AI ethical risk, the database being stored in the AI model provision/rejection determination unit 105. In FIG. 5, three use cases are assumed for the facial authentication AI model, and the examination results of the AI ethical risk for each of the use cases are compiled into a database. For example, the first combination indicates that “facial authentication AI model” is used for “criminal investigation”, and the AI ethical risk in this case is set as “high”. For this reason, in the case of this combination, the AI model provision/rejection determination unit 105 rejects provision of the facial authentication AI model.

The configuration of the AI model provision control system 100 has thus been described.

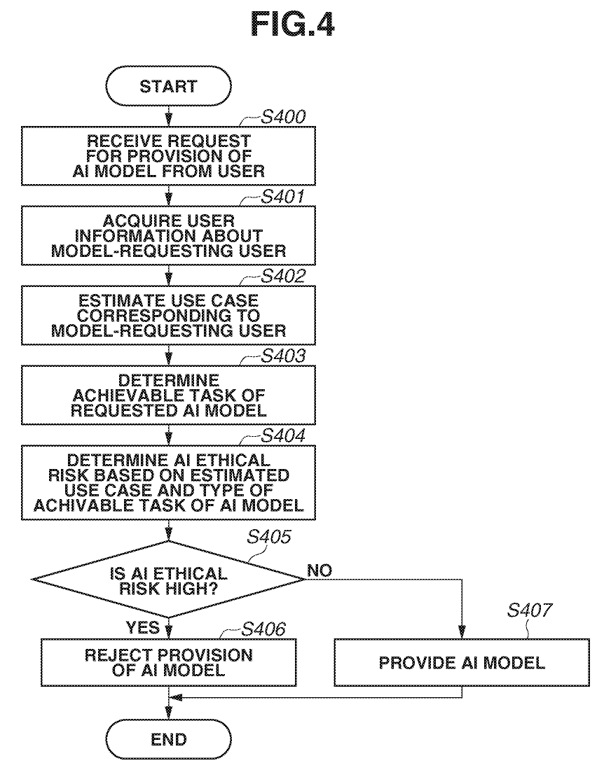

Next, an operation sequence of the AI model provision control system 100 will be described with reference to FIG. 4. A processing method performed by the AI model provision control system 100 will be described.

First, in step S400, the AI model provision control system 100 receives a request for provision of an AI model from a user. For example, the AI model provision control system 100 receives a request for a facial authentication AI model from a user A. For simplicity, a user who has sent a request for provision of an AI model will be referred to as a model-requesting user. Further, an AI model for which the model-requesting user has sent a request will be referred to as a requested AI model.

Next, in the step S401, the user information management unit 102 acquires user information about the model-requesting user. The user information is information about the user who wishes to use the pre-trained AI model.

Next, in step S402, based on the user information acquired in step S401, the use case estimation unit 103 estimates the use case in a case where the model-requesting user uses the requested AI model. For example, the use case estimation unit 103 estimates this use case, based on the information about the organization to which the model-requesting user belongs, the information being illustrated in FIG. 2. For example, as illustrated in FIG. 2, “criminal investigation” is estimated as the use case corresponding to the user A.

Next, in step S403, the AI model management unit 104 determines the achievable task of the requested AI model, as illustrated in FIG. 3.

Next, in step S404, the AI model provision/rejection determination unit 105 determines the level of the AI ethical risk, based on the use case estimated in step S402 and the achievable task of the requested AI model determined in step S403. For example, as illustrated in FIG. 5, when the user A requests provision of a facial authentication AI model, since there is a possibility that the user A will use the facial authentication AI model for criminal investigation, the AI model provision/rejection determination unit 105 determines that the AI ethical risk is high.

Next, in step S405, the AI model provision/rejection determination unit 105 determines whether the model-requesting user is suitable for using the requested AI model, based on the level of the AI ethical risk determined in step S404. If the AI ethical risk is high (YES in step S405), the AI model provision/rejection determination unit 105 determines that the model-requesting user is unsuitable for using the requested AI model, and the process proceeds to step S406. If the AI ethical risk is not high (NO in step S405), the AI model provision/rejection determination unit 105 determines that the model-requesting user is suitable for using the requested AI model, and the process proceeds to step S407.

In step S406, the AI model provision/rejection determination unit 105 rejects provision of the requested AI model to the model-requesting user.

In step S407, the AI model provision/rejection determination unit 105 provides the requested AI model to the model-requesting user.

The AI model provision control system 100 according to the present embodiment has thus been described.

As described above in detail, according to the present embodiment, the AI model provision control system 100 estimates the use case of an AI model (how an AI model is used) when this AI model is provided to a user. If it is determined that how the AI model is used has a high risk in terms of AI ethics, the AI model provision control system 100 rejects the provision of the AI model.

As a result, it is possible to prevent an AI model from being used with a high risk in terms of AI ethics. For example, it is possible to prevent an AI model from violating privacy and human rights of people.

In general, a model-requesting user (a user who requests the AI model provision control system 100 to provide an AI model) does not necessarily have sufficient knowledge about AI ethics and AI laws and regulations. Providing (or not providing) an AI model to such a user after determining the AI ethical risk can prevent the user from inadvertently using the AI model (due to lack of knowledge, etc.) in a problematic way in terms of AI ethics, and is, therefore, very beneficial for the user. In addition, the service provider operating the AI model provision control system 100 can also prevent their users from using AI models provided through their service in a problematic way in terms of AI ethics. This leads to provision of a reliable service, which is beneficial for the service provider.

The present embodiment has been described in detail based on an example in which, when the “user A” who belongs to the criminal investigation organization wishes to use the “facial authentication AI model”, the AI model provision control system 100 rejects provision of the AI model. Although the AI model provision control system 100 rejects the provision of the AI model in this example, the AI model provision control system 100 provides the AI model in an example in which the AI ethical risk is determined to be small.

For example, in a case where the “user C” who belongs to the cram school operating organization wishes to use the “facial authentication AI model”, “attendance check at a class” can be estimated as the use case of the AI model. Since using facial authentication for attendance check at a class is generally considered to have a low AI ethical risk, the AI model provision control system 100 can provide the AI model.

As described above, according to the present embodiment, the AI model provision control system 100 can determine whether to provide the same “facial authentication AI model”, depending on the use case (how this AI model is used). In the determination of the AI ethical risk, not only the kind of task the AI model executes but also the way the AI model is used is an important factor. For this reason, performing the determination of the AI ethical risk based on the combination of the task and the use case is an effective method.

In addition, as a method for determining the provision by the AI model provision/rejection determination unit 105, the present embodiment has been described based on a method in which a person examines a determination criterion in advance, and the examination results are compiled into a database.

There is no absolute criterion that can be applied universally for determination of the AI ethical risk, and it is quite conceivable that the criterion would vary depending on the country or region where the service of the AI model provision control system 100 is implemented. This is because AI ethics themselves are strongly affected by social and cultural backgrounds. In addition, the laws and regulations related to AI ethics generally differ from country to country. Furthermore, it can be easily imagined that the perspective and policy of the service provider operating the AI model provision control system 100 on AI ethics affect the examination of the criterion for the provision determination. Further, social tolerance for AI ethics could also change over time.

Thus, the determination of whether to provide an AI model may vary depending on the country or region where the AI model provision control system 100 is operated, may vary depending on the service provider operating the AI model provision control system 100, or may vary depending on the era. The AI model provision control system 100 according to the present embodiment is configured as a flexible system capable of absorbing such differences in social and temporal/era backgrounds relating to AI ethics.

### (Second Embodiment)

The first embodiment has been described in detail based on an example in which the use case of an AI model used by a user is estimated by referring to the organization to which the user belongs.

A second embodiment will be described based on an example in which the use case of an AI model is estimated by referring to images previously captured by a user, in addition to the organization to which the user belongs.

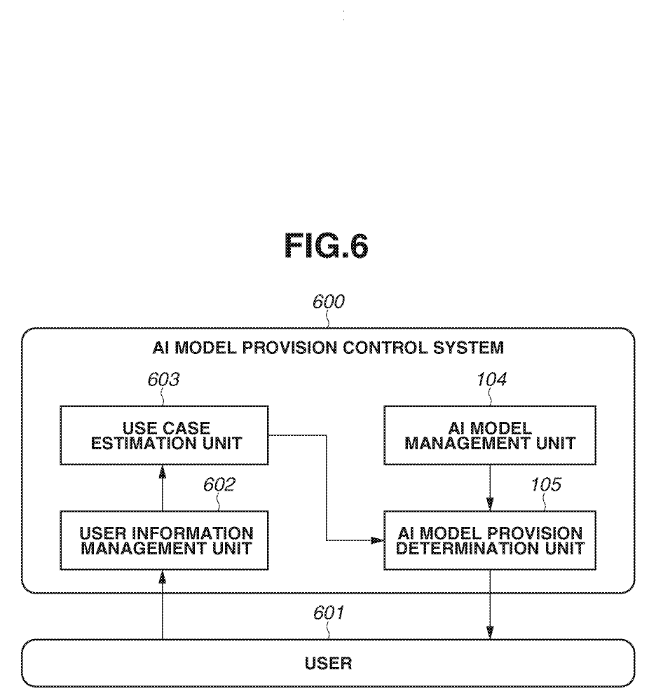

FIG. 6 is a block diagram illustrating a configuration example of an AI model provision control system 600 according to the second embodiment. In FIG. 6, the same reference numerals between FIG. 1 and FIG. 6 denote the same components, and description thereof will be omitted.

The AI model provision control system 600 includes a user information management unit 602, a use case estimation unit 603, an AI model management unit 104, and an AI model provision/rejection determination unit 105.

The present embodiment assumes that the AI model provision control system 600 manages and provides AI models that are usable with digital cameras, as in the first embodiment. Further, according to the present embodiment, the AI model provision control system 600 not only manages and provides AI models but also manages images captured by digital camera users.

When using the AI model provision control system 600, a user 601 performs user registration by disclosing his or her personal information. Further, the user 601 manages images captured by his or her own digital camera in the AI model provision control system 600. The personal information about the user 601 and the images captured by the user 601 will be collectively referred to as user information.

The user information management unit 602 manages the user 601 and the user information about the user 601 in association with each other. The user information management unit 602 manages the association between an individual user and his or her personal information (the name and the organization to which the user belongs), and the association between an individual user and the images captured by the user.

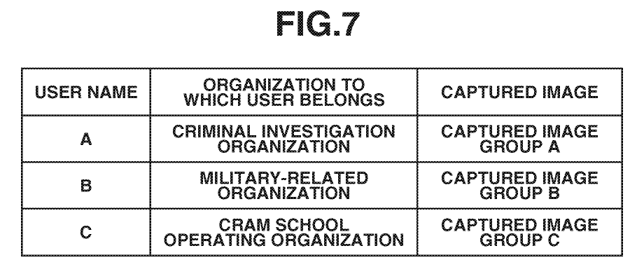

FIG. 7 schematically illustrates a management method of the user information in the user information management unit 602. FIG. 7 illustrates how the organizations to which users A, B, and C belong and the captured images are managed. For example, FIG. 7 illustrates that the user A belongs to a “criminal investigation organization”, and the images previously captured by the user A are managed as a “captured image group A”.

When an AI model is provided to a user, the use case estimation unit 603 estimates how the user is to use the AI model based on the user’s personal information and captured images managed by the user information management unit 602. Since the method for estimating a use case from the user’s personal information (the organization to which the user belongs) has already been described in detail in the first embodiment, a method for estimating a use case based on the images captured by the user will be described hereinafter.

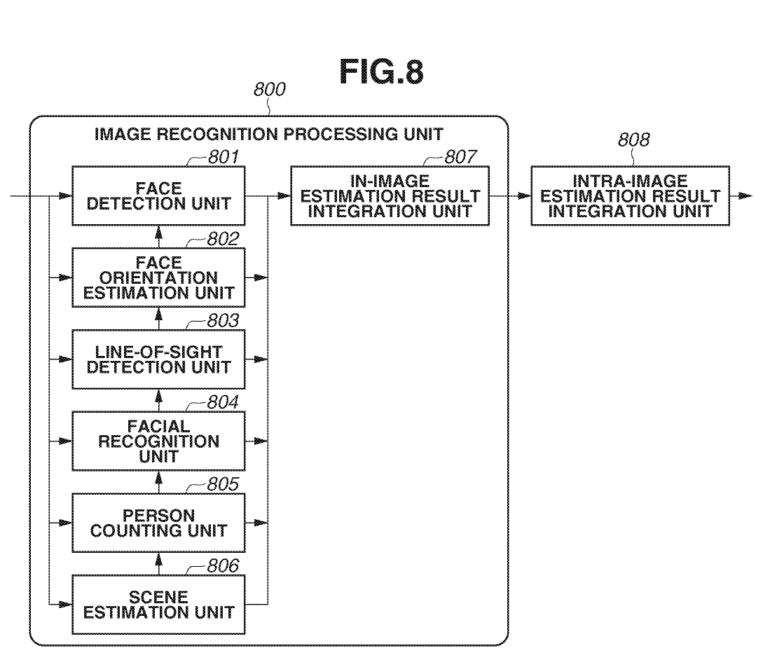

FIG. 8 is a block diagram illustrating units for estimating a use case based on captured images in the use case estimation unit 603.

The use case estimation unit 603 includes an image recognition unit 800 and an inter-image estimation result integration unit 808. The image recognition processing unit 800 includes a face detection unit 801, a face direction estimation unit 802, a line-of-sight detection unit 803, a facial authentication unit 804, a person counting unit 805, a scene estimation unit 806, and an in-image estimation result integration unit 807.

Each of the units in FIG. 8 corresponds to a technique for estimating the locations of objects (for example, a person and a face) captured in an image and for estimating the attributes of the objects, and also corresponds to processing for estimating a scene where the image has been captured. That is, the processing may be referred to as image authentication processing. All the processing can be performed by using existing known image authentication techniques.

For example, the face detection unit 801 may use a method in which shapes corresponding to the constituent elements in a face region, such as a nose, a mouth, and eyes, are extracted, the size of the face is estimated from the sizes of both eyes and the distance between both eyes, and a region surrounded by a region of the estimated size is set as the face region by using a position corresponding to the center of the nose as a reference point.

The scene estimation unit 806 performs, for example, object detection on an image, estimates “what” is captured “where”, and estimates a scene from the positional relationship of the detected objects. For example, if a bench or a swing is captured in the image, the scene estimation unit 806 estimates a place such as “park” as the place where the image has been captured. Similarly, if there are buildings on both sides of a road in the image, the scene estimation unit 806 can estimate that the image has been captured on “road”.

The face direction estimation unit 802 estimates the direction of the face of a person within an image. The line-of-sight detection unit 803 detects the direction of the line of sight of a person within an image. The facial authentication unit 804 authenticates the face of a person within an image.

The person counting unit 805 counts the number of people within an image.

In recent years, in many cases, such image authentication processing is executed by using AI models. Accordingly, the image authentication processing of the units 801 to 806 may be executed by using the AI models managed by the AI model provision control system 600 (the AI models managed by the AI model management unit 104).

The image recognition processing unit 800 receives captured images managed by the user information management unit 602, and performs the image authentication processing of each of the units 801 to 806 on the received captured images.

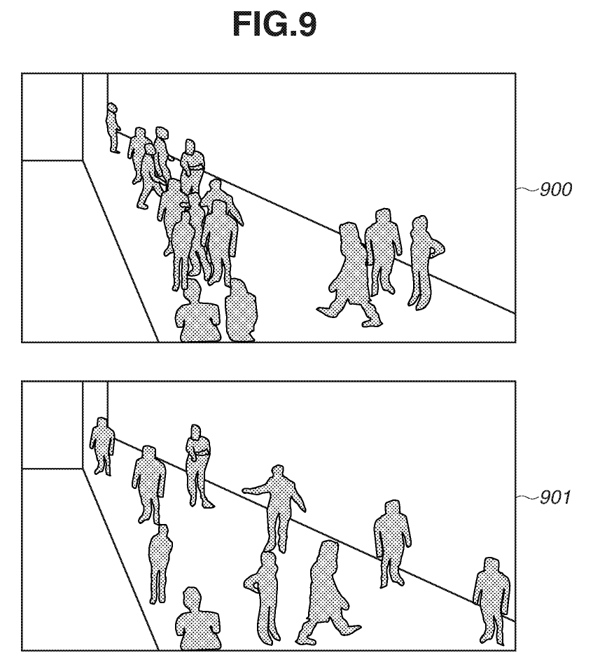

FIG. 9 illustrates captured images 900 and 901, which are examples of the captured images. When the image recognition processing unit 800 performs the image authentication processing on the captured image 900, “the location of the face”, “the direction of the face”, “the direction of line of sight”, etc., are estimated for each person within the image. Further, the person counting unit 805 estimates the number of people within the image, and the scene estimation unit 806 estimates the location where the image has been captured. The estimation results obtained in the image authentication processing are sent to the in-image estimation result integration unit 807.

The in-image estimation result integration unit 807 receives the results of the authentication processing performed by the units 801 to 806 on the image (for example, the image 900) input to the image recognition processing unit 800. For example, the in-image estimation result integration unit 807 receives the face locations within the image from the face detection unit 801, and receives the result of the face direction estimation performed on each of the faces within the image from the face direction estimation unit 802.

Based on the individual authentication processing results, the in-image estimation result integration unit 807 obtains an estimation result indicating what image is captured and how the image is captured in one image. For example, in the case of the captured image 900, the in-image estimation result integration unit 807 integrates the individual estimation results obtained from the authentication processing of the units 801 to 806, and obtains an estimation result, which indicates that “there are 15 people in a variety of (apparent) sizes, each person has a different face direction and is looking in a different direction, and the scene is estimated to be on the road”.

Further, the in-image estimation result integration unit 807 estimates a use case indicating how the image has been captured based on the obtained estimation result. In the case of the captured image 900, since the image includes a plurality of people captured on the road with different face directions and different line-of-sight directions, the in-image estimation result integration unit 807 estimates that this image has been taken on a road by a digital camera, capturing people walking on the road. That is, the in-image estimation result integration unit 807 estimates that the captured image 900 has been captured in a use case “capturing an image of people in a public space”.

As a technique for estimating a use case from an individual estimation result, it is conceivable to use a neural network such as a deep net. That is, if a neural network that receives an individual estimation result as an input and outputs a use case as an output is prepared, the use case can be estimated.

Such a neural network can be trained by using the following training data. That is, a large number of images whose use cases (situations in which the images are captured) are known are prepared, and the authentication processing of each of the units 801 to 806 is performed on each of the images. In this way, individual estimation results are obtained. Next, a large number of pairs of estimation results and their corresponding use cases are prepared, and the neural network is trained by using these pairs as training data. As a result, the neural network that estimates a use case from an individual estimation result can be developed.

The in-image estimation result integration unit 807 configured as described above can estimate a use case based on a captured image.

The inter-image estimation result integration unit 808 integrates the use cases, which have been output from the in-image estimation result integration unit 807, the use cases corresponding to a plurality of images captured by the same user 601. For example, assuming that the image 900 and the image 901 have been captured by the same user 601, the inter-image estimation result integration unit 808 integrates the estimated use cases corresponding to these captured images.

The inter-image estimation result integration unit 808 can perform the integration of the estimated use cases by using a method based on majority rule. In the case of the captured images 900 and 901, since these images have been captured at the same location and appear to be very similar, it is assumed that the use cases of the two images will be estimated as “capturing an image of people in a public space”. In such a case, the estimated use case corresponding to the user who has captured the images 900 and 901 is “capturing an image of people in a public space”.

As described above in detail, the use case estimation unit 603 uses the images captured by the user, to estimate what type of image capturing is preferred by the user and in what use case the user performs image capturing. For example, the use case estimation unit 603 outputs an estimation result indicating that the use case corresponding to the user who has captured images such as the images 900 and 901 is “capturing an image of people in a public space”.

The use case estimation unit 603 estimates a use case based on the images 900 and 901 captured by the model-requesting user in the past. For example, as illustrated in FIG. 8, the use case estimation unit 603 estimates a use case based on the face direction of an individual person, the line of sight of an individua person, the number of people, etc., within the captured images.

The present embodiment has been described based on an example in which a use case is estimated by referring to images that a user has previously captured, in addition to the organization to which the user belongs. In a case where the use case estimated from the organization to which the user belongs is different from the use case estimated from the captured images, the estimation result to be prioritized may be determined in advance. Alternatively, additional processing for integrating both the estimation results may be performed. For example, the use case “criminal investigation” as described in the first embodiment and the use case “capturing an image of people in a public space” as described in the present embodiment are compatible with each other, and thus, a use case “criminal investigation using an image of people in a public space” may be created as an integrated use case.

The configuration of the AI model provision control system 600 has thus been described.

An operation sequence of the AI model provision control system 600 is almost the same as that illustrated in FIG. 4, and thus, description thereof will be omitted.

According to the present embodiment, the AI model provision control system 600 refers to images captured by a model-requesting user (a user who requests the AI model provision control system 600 to provide an AI model) in the past as user information, and estimates a use case that the model-requesting user wishes to achieve by using the AI model (the requested AI model). Next, the AI model provision control system 600 determines whether to provide the AI model based on the estimated use case and the achievable task associated with the requested AI model.

In this way, the AI model provision control system 600 can determine whether the model-requesting user is likely to use the requested AI model in a problematic way in terms of AI ethics. By determining whether to provide the AI model based on this determination, the AI model provision control system 600 can reduce the problematic use of the AI model in terms of AI ethics.

### (Third Embodiment)

A third embodiment will be described based on an example in which an AI model provision control system provides an AI model to the user together with an expiration date. Setting an expiration date for an AI model can avoid a situation in which the AI model is continuously used even though the use case estimated at the time of previous provision of the AI model has changed over time. That is, the AI model provision control system according to the third embodiment can prevent an AI model from being continuously used even though its use case has changed from the initially estimated use case.

In addition, the expiration date is updated when the user who has received the AI model registers a newly captured image in the AI model provision control system. In this way, whether the use case has changed can be checked through the captured image newly registered. With the configuration described above, the use case can be periodically checked, and the AI model can be prevented from being continuously used in a problematic way in terms of AI ethics. Thus, the AI model provision control system can be operated without impairing user convenience.

An existing known method can be used to stop the operation of the AI model in accordance with its expiration date. For example, providing a license period for software to enable the software is widely and commonly practiced, and a similar method may be used to enable and disable the operation of an AI model.

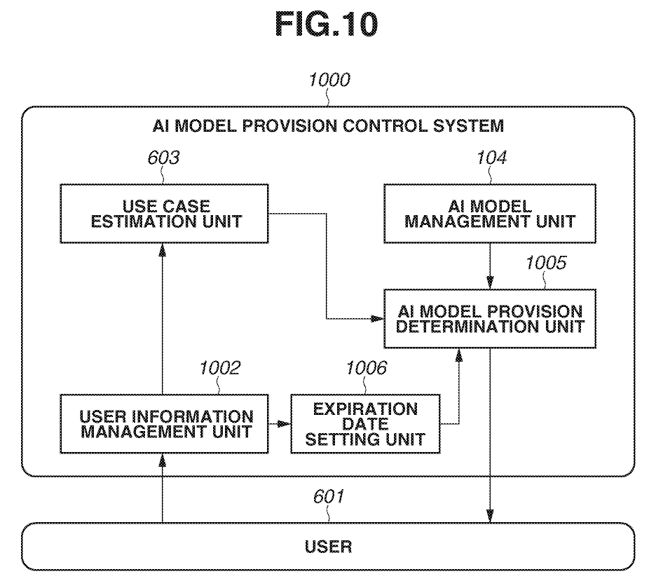

FIG. 10 is a block diagram illustrating a configuration example of an AI model provision control system 1000 according to the third embodiment. In FIG. 10, the same reference numerals as those in FIGS. 1 and 6 denote to the same components, and description thereof will be omitted.

The AI model provision control system 1000 includes a user information management unit 1002, a use case estimation unit 603, an AI model management unit 104, an AI model provision/rejection determination unit 1005, and an expiration date setting unit 1006.

It is assumed that the AI model provision control system 1000 according to the present embodiment not only manages and provides AI models but also manages images captured by digital camera users, as in the second embodiment. Further, as described above, an expiration date is set for each of the AI models provided by the AI model provision control system 1000.

As with the user information management unit 602, the user information management unit 1002 manages the association between an individual user and his or her personal information (the name and the organization to which the user belongs) and the association between an individual user and his or her captured images. Further, the user information management unit 1002 manages the last update dates of the captured images managed by the AI model provision control system 1000.

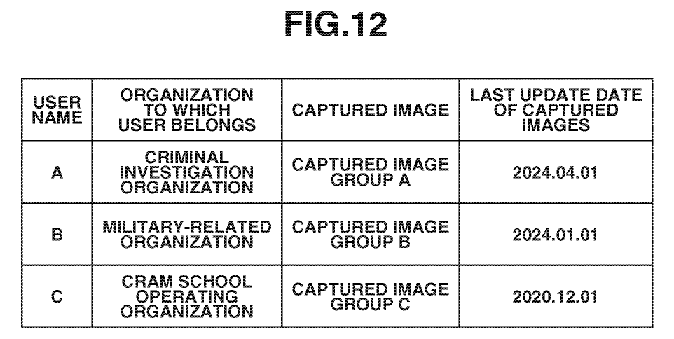

FIG. 12 schematically illustrates a management method of user information in the user information management unit 1002.

FIG. 12 illustrates how the organizations to which users A, B, and C belong, captured images, and the last update dates of the captured image groups are managed. For example, FIG. 12 indicates that the user A belongs to a “criminal investigation organization”, the images that the user A has previously captured are managed as a “captured image group A”, and the last update date of the captured images is “2024.04.01”.

The user information management unit 1002 sends the “last update date of the captured images” corresponding to a model-requesting user (a user who requests the AI model provision control system 1000 to provide an AI model) to the expiration date setting unit 1006.

The AI model provision/rejection determination unit 1005 performs the same determination as that performed by the AI model provision/rejection determination unit 105. That is, the AI model provision/rejection determination unit 1005 determines whether to provide an AI model to a user 601 based on the use case estimated by the use case estimation unit 603 and the achievable task of the AI model managed by the AI model management unit 104. In addition, the AI model provision/rejection determination unit 1005 performs final determination of whether to provide the AI model to the user 601 by referring to the expiration date received from the expiration date setting unit 1006.

As the determination of whether to provide the AI model by using the expiration date, the AI model provision/rejection determination unit 1005 compares the received expiration date with the current date, and if the expiration date indicates a past date, the AI model provision/rejection determination unit 1005 determines to reject the provision of the AI model. If the expiration date indicates a future date, the AI model provision/rejection determination unit 1005 determines to provide the AI model. When providing the AI model, the AI model provision/rejection determination unit 1005 provides the AI model together with the expiration date.

The expiration date setting unit 1006 sets an expiration date until which the model-requesting user can use the requested AI model (a time limit until which the AI model normally operates), based on the last update date of the images captured by the model-requesting user in the past, the last update date having been sent from the user information management unit 1002. For example, the expiration date is set to one year from the last update date of the captured images.

The configuration of the AI model provision control system 1000 has thus been described.

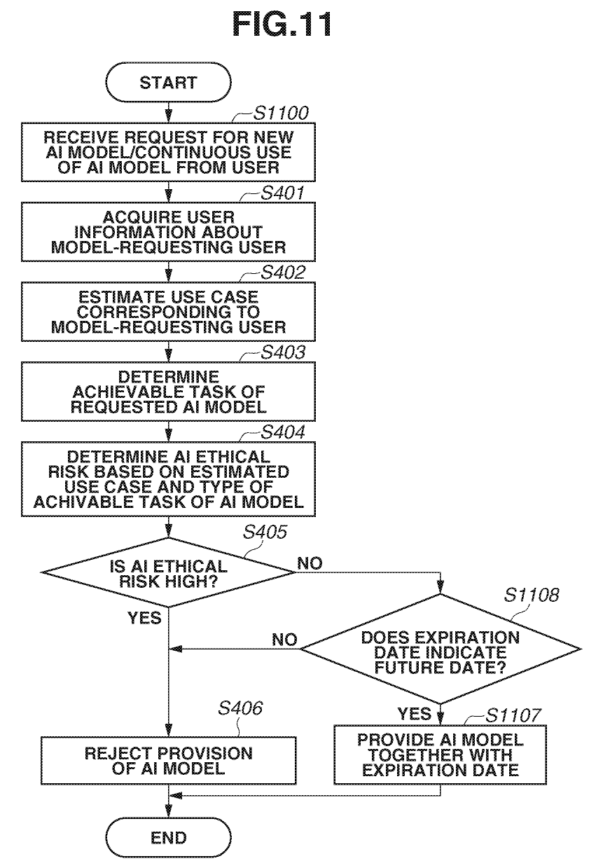

FIG. 11 illustrates an operational sequence of the AI model provision control system 1000. In FIG. 11, the same reference characters between FIG. 4 and FIG. 11 denote the same processing contents, and description thereof will be omitted.

First, in step S1000, the AI model provision control system 1000 receives a request for provision of an AI model or for continuous use of an AI model from a user. According to the present embodiment, since an expiration date is set for each of the AI models to be provided, the AI model provision control system 1000 may receive a request for continuous use of an AI model by extending the corresponding expiration date.

Steps S401 to S405 are the same as those in FIG. 4. In step S405, if the AI ethical risk is high (YES in step S405), the process proceeds to step S406. If the AI ethical risk is not high (NO in step S405), the process proceeds to step S1108.

In step S1108, the AI model provision/rejection determination unit 1005 determines whether the expiration date indicates a future date. If the expiration date indicates a past date (NO in step S1108), the process proceeds to step S406. If the expiration date indicates a future date (YES in step S1108), the process proceeds to step S1107.

In step S406, the AI model provision/rejection determination unit 1005 rejects provision of the requested AI model to the model-requesting user.

In step S1107, the AI model provision/rejection determination unit 1005 provides the requested AI model together with its expiration date to the model-requesting user.

The AI model provision control system 1000 configured as described above can continuously encourage the user to register captured images (to manage captured images in the AI model provision control system 1000). That is, if no captured image is registered, the use of an AI model will eventually expire. To prevent stop of the operation of the AI model due to the expiration of the use of the AI model, the user needs to continuously register captured images.

By estimating a use case with continuously registered captured images, even when the use case corresponding to the user changes over time, the change in the use case can be followed at the timing of the expiration date of the AI model.

In this way, the AI model provision control system 1000 can prevent an AI model from being used even though its use case has changed from the previously estimated use case. Further, with the configuration described above, the AI model provision control system 1000 can periodically check the use case, and can prevent the AI model from being continuously used in a problematic way in terms of AI ethics. Thus, the AI model provision control system 1000 can be operated without impairing user convenience.

The present embodiment has been described based on an example in which the user information management unit 1002 manages the last update dates of the captured images. However, since whether a captured image has been recently registered (whether the use case estimation can be performed with a recently registered captured image) is the key factor, any information other than the last update date may be used, as long as the information indicates the registration time of a captured image.

In addition, in a case where the AI model currently being requested by a user is an AI model with which the user has already been provided, if the AI model provision/rejection determination unit 1005 determines that the AI model can be provided, only a new expiration date may be provided. This is because the AI model itself has already been provided.

In addition, the captured images used for the use case estimation by the use case estimation unit 603 may be limited to the images captured within a period in which the current expiration date is valid. That is, the use case estimation may be performed by using recently captured images among those registered by the user. It is more suitable to perform the use case estimation by using such images captured within a period in which the current expiration date is valid, because a change in the use case corresponding to the user can be followed more promptly.

In the above-described example, the expiration date setting unit 1006 sets the expiration date to one year from the last update date of the captured images. However, the setting of the expiration date is not limited to such example. The service provider who manages the AI model provision control system 1000 may determine how the expiration date is set. For example, the service provider may set the expiration date to a date after any period of time from the last update date or may set any length as the validity period for the AI model.

When the expiration date is set to a date in the near future, a change in the use case can be followed promptly. However, it is inconvenient for the user because this will increase the update frequency of the expiration date of the AI model. On the other hand, if a change in the use case can be followed promptly, it is easier to prevent the AI model from being continuously used in a problematic way in terms of AI ethics. Accordingly, there is a trade-off between the convenience of the user and the risk of occurrence of an AI ethical problem.

In addition, even in a case where an AI model has already been provided in the past to the current model-requesting user, if it is determined that the user is likely to use the AI model in a problematic way in terms of AI ethics in view of a combination of the use case estimated this time and the AI model provided in the past, the AI model provision/rejection determination unit 1005 may invalidate the AI model provided in the past (may set the AI model to a state in which the expiration date has passed).

In this case, after determining that the model-requesting user is suitable for using the requested AI model, the AI model provision/rejection determination unit 1005 can determine that the model-requesting user is unsuitable for using the requested AI model in accordance with a new use case estimated by the use case estimation unit 603.

For example, the AI model provision/rejection determination unit 1005 determines that the model-requesting user is suitable for using the requested AI model, and provides the requested AI model to the model-requesting user. Subsequently, the AI model provision/rejection determination unit 1005 can determine that the model-requesting user is unsuitable for using the requested AI model in accordance with a new use case estimated by the use case estimation unit 603, and can invalidate the use of the requested AI model.

### (Fourth Embodiment)

The first to third embodiments have been described based on examples in which the AI model provision/rejection determination unit performs determination between two choices: to provide the AI model or reject providing the AI model. However, the choice is not limited to these two choices. As described above, the present embodiment is directed to preventing AI models from being used in problematic ways in terms of AI ethics.

Thus, for example, it is conceivable to provide an AI model after displaying a warning message, rather than rejecting provision of the AI model. That is, even in a case where it is estimated that a facial authentication AI model is used in criminal investigation as described in the first embodiment, the facial authentication AI model may be provided together with a warning message “using facial authentication in criminal investigation has a risk of causing an AI ethical problem” or “using facial authentication in criminal investigation is prohibited by law”.

In this case, if the AI model provision/rejection determination unit determines that the model-requesting user is suitable for using the requested AI model, the AI model provision/rejection determination unit provides the requested AI model to the model-requesting user. On the other hand, if the AI model provision/rejection determination unit determines that the model-requesting user is unsuitable for using the requested AI model, after displaying the warning message to the model-requesting user, the AI model provision/rejection determination unit provides the requested AI model to the model-requesting user.

In addition, it is also conceivable to provide an AI model with a restricted function. For example, if it is estimated that a facial authentication AI model will be used when an image of people in a public space is captured as described in the second embodiment, the facial authentication AI model may be provided after its function is restricted such that the facial authentication AI model would not operate unless a face to be identified has a certain size (an apparent size in the image) for identification. Since the faces included in images such as the image 900 or 901 are small, if such functional restriction is applied, the facial authentication performed on images such as the image 900 or 901 can be substantially disabled.

In this case, if the AI model provision/rejection determination unit determines that the model-requesting user is suitable for using the requested AI model, the AI model provision/rejection determination unit provides the requested AI model to the model-requesting user. On the other hand, if the AI model provision/rejection determination unit determines that the model-requesting user is unsuitable for using the requested AI model, the AI model provision/rejection determination unit provides the requested AI model to the model-requesting user after restricting the function of the requested AI model.

As described above, according to any one of the first to fourth embodiments, the AI model provision control system estimates how an AI model is used by a recipient when providing the AI model to the recipient, and rejects the provision of the AI model when the AI model provision control system determines that the AI model is likely to be used inappropriately. In this way, the AI model provision control system can prevent the AI model from being used in a manner that violates privacy and human rights of people. That is, the AI model provision control system can prevent the AI model from being used in a problematic way in terms of AI ethics.

### (Other Embodiments)

The present disclosure can also be realized by processing in which a program that realizes one or more functions of the above-described embodiments is supplied to a system or an apparatus via a network or a storage medium, and one or more processors in a computer of the system or the apparatus read and execute the program. The present disclosure can also be realized by a circuit (for example, an application specific integrated circuit (ASIC)) that implements one or more functions.

The above-described embodiments are merely specific examples for implementing the present disclosure, and the technical scope of the present disclosure is not interpreted in a limited manner by these embodiments. That is, the present disclosure can be implemented in various forms without departing from the technical idea or the main features thereof.

The present disclosure can determine whether a user is suitable for using an AI model.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-214413, filed December 9, 2024, which is hereby incorporated by reference herein in its entirety.

What is claimed is:

1. An artificial intelligence (AI) model provision control system, comprising:
least one processor; and
at least one memory having stored thereon instructions which, when executed by the at least one processor, cause the AI model provision control system at least to:
estimate, based on information about a user who uses a pre-trained AI model, a use case in a case where the user uses the AI model; and
determine whether the user is suitable for using the AI model based on the estimated use case,
wherein the AI model provision control system provide the AI model based on the determination.

2. The AI model provision control system according to claim 1, wherein the AI model provision control system estimates the use case based on information about an organization to which the user belongs.

3. The AI model provision control system according to claim 1, wherein the AI model provision control system estimates the use case based on an image previously captured by the user.

4. The AI model provision control system according to claim 3, wherein the AI model provision control system estimates the use case based on a face direction of a person, a line of sight, or a number of people within the captured image.

5. The AI model provision control system according to claim 1, wherein the AI model provision control system determines whether the user is suitable for using the AI model based on an achievable task of the AI model and the estimated use case.

6. The AI model provision control system according to claim 1, wherein the AI model provision control system sets an expiration date until which the AI model is usable by the user.

7. The AI model provision control system according to claim 6, wherein the AI model provision control system sets the expiration date based on information relating to an image previously captured by the user.

8. The AI model provision control system according to claim 6,
wherein, in a case where the AI model provision control system determines that the user is suitable for using the AI model and the expiration date indicates a future date, the AI model provision control system provides the AI model with the expiration date to the user,
wherein, in a case where the AI model provision control system determines that the user is suitable for using the AI model and the expiration date indicates a past date, the AI model provision control system does not provide the AI model to the user, and
wherein, in a case where the AI model provision control system determines that the user is unsuitable for using the AI model, the AI model provision control system does not provide the AI model to the user.

9. The AI model provision control system according to claim 1, wherein the AI model provision control system determines that the user is unsuitable for using the AI model in accordance with a newly estimated use case after the AI model provision control system has previously determined that the user is suitable for using the AI model.

10. The AI model provision control system according to claim 9, wherein the AI model provision control system determines that the user is unsuitable for using the AI model in accordance with a newly estimated use case and invalidates use of the AI model after the AI model provision control system has previously determined that the user is suitable for using the AI model and has previously provided the AI model to the user.

11. The AI model provision control system according to claim 1,
wherein, in a case where the AI model provision control system determines that the user is suitable for using the AI model, the AI model provision control system provides the AI model to the user, and
wherein, in a case where the AI model provision control system determines that the user is unsuitable for using the AI model, the AI model provision control system does not provide the AI model to the user.

12. The AI model provision control system according to claim 1,
wherein, in a case where the AI model provision control system determines that the user is suitable for using the AI model, the AI model provision control system provides the AI model to the user, and
wherein, in a case where the AI model provision control system determines that the user is unsuitable for using the AI model, the AI model provision control system provides the AI model to the user after displaying a warning message to the user.

13. The AI model provision control system according to claim 1,
wherein, in a case where the AI model provision control system determines that the user is suitable for using the AI model, the AI model provision control system provides the AI model to the user, and
wherein, in a case where the AI model provision control system determines that the user is unsuitable for using the AI model, the AI model provision control system provides the AI model to the user after restricting a function of the AI model.

14. A processing method of an AI model provision control system, the processing method comprising:
estimating, based on information about a user who uses a pre-trained AI model, a use case in a case where the user uses the AI model; and
determining whether the user is suitable for using the AI model based on the use case estimated by the use case estimation step.

15. A non-transitory computer-readable storage medium storing a program for causing a computer to function as the AI model provision control system, executed by the at least one processor, cause the AI model provision control system at least to:
estimate, based on information about a user who use a pre-trained AI model, a use case in a case where the user uses the AI model; and
determine whether the user is suitable for using the AI model based on the estimated use case,
wherein the AI model provision control system provides the AI model based on the determination.
